(19) United States
(12) Patent Application Publication
(10) Pub. No.: US 2026/0241483 A1
(43) Pub. Date: Aug. 20, 2026

(54) METHOD FOR MONITORING THE STATUS OF COMPONENTS OF A LASER BEAM SOURCE

(71) Applicant: TRUMPF Laser SE, Schramberg (DE)

(72) Inventor: Ralf Bartmuss, Dietingen (DE)

(21) Appl. No.: 19/642,658

(22) Filed: Apr. 9, 2026

Related U.S. Application Data
(63) Continuation of application No. PCT/EP2024/078222, filed on Oct. 8, 2024.

(30) Foreign Application Priority Data
Oct. 10, 2023 (DE) 10 2023 127 585.2

(51) Int. Cl. B23K 26/03; B23K 37/006

(52) U.S. Cl. CPC B23K 26/03; B23K 37/006

(57) ABSTRACT

A method for monitoring a status of components of a laser beam source in a laser processing machine, the method including determining measurement values of properties of the components and comparing each of the measurement values with an error limit value, a faulty status of the component being indicated based on the measurement value falling below or exceeding the error limit value. An error status is assigned and the laser beam source is shut down if the error limit value is violated. For each error limit value, a tolerance value is defined, the violation of which by a measurement value results in a warning status being assigned. Each error limit value is associated with a second, minimum tolerance value which is more narrowly defined than the tolerance value. An early warning status is assigned based on violation of the second, minimum tolerance value by a measurement value.

### CROSS REFERENCE TO RELATED APPLICATIONS

This application is a continuation of International Application No. PCT/EP2024/078222 (WO 2025/078342 Al), filed on October 8, 2024, and claims benefit to German Patent Application No. DE 10 2023 127 585.2, filed on October 10, 2023. The aforementioned applications are hereby incorporated by reference herein.

### FIELD

The invention relates to a method for monitoring the status of components of a laser beam source in a laser processing machine.

### BACKGROUND

The laser beam source is the core component of a laser processing machine. Its most important components are the optics and beam distribution, the cooling circuit, and its control functions. These components are therefore monitored by sensors and their measurement values are evaluated during production. If a predetermined error limit value is violated by one of the measurement values, an error message is generated and the production of the laser processing machine is interrupted. In the case of less serious malfunctions of individual components, i.e., when measurement values of the components exceed or fall below an initial tolerance value but do not yet violate the error limit value, a warning message is issued. The machine operator then has the option of switching off the laser beam source in a controlled manner and repairing or replacing the component in question. The error and warning messages can be read directly on the machine or transmitted to remote monitoring stations and service companies.

However, the known methods only issue a message if the correct functioning of the laser processing machine is already impaired.

### SUMMARY

In an embodiment, the present disclosure provides a method for monitoring a status of components of a laser beam source in a laser processing machine, the method comprising determining measurement values of properties of interest of the components of the laser beam source and comparing each of the measurement values with an error limit value, a faulty status of the component being indicated based on the measurement value falling below or exceeding the error limit value. The method further comprises, based on the error limit value being violated by the component, assigning an error status and shutting down the laser beam source and defining, for each error limit value, a tolerance value, the violation of which by at least one measurement value of the measurement values results in a warning status being assigned. Each error limit value is associated with a second, minimum tolerance value which is more narrowly defined than the tolerance value. The method further comprises assigning an early warning status based on violation of the second, minimum tolerance value by at least one measurement value of the measurement values of the component.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1a and 1b show measurement diagrams of a standard error monitoring method and a monitoring method according to the present disclosure for a laser beam source;

FIG. 2 shows a traffic light signal generated by a method according to the present disclosure; and

FIG. 3 shows a block diagram of a method for monitoring a laser beam source.

### DETAILED DESCRIPTION

In an embodiment, the present disclosure provides a method for monitoring the laser beam source of a laser processing machine, with which faulty tendencies of components of the laser beam source can be determined in the background and during operation of the machine, even before the occurrence of errors that impair the correct functioning of the machine.

The foregoing is achieved according to the present disclosure by a method for monitoring the status of components of a laser beam source in a laser processing machine, the method comprising: determining measurement values of the properties of interest of the components of the laser beam source, and comparing each of said measurement values with an error limit value, a faulty status of the component being indicated when the measurement value falls below or exceeds said error limit value; in the event the error limit value being violated by a measurement value of the component, assigning an error status and shutting down the laser beam source; and defining, for each error limit value, a tolerance value, the violation of which by a measurement value of the component results in a warning status being assigned, characterized in that each error limit value is associated with a second, minimum tolerance value which is more narrowly defined than the tolerance value and the violation of which by a measurement value of the component results in an early warning status being assigned.

With this method, in addition to the actual error limit value and a first tolerance value, a further, minimum tolerance value is assigned to each measurement value, the violation of which does not yet indicate a condition that impairs the operation of the machine, but represents an early warning for a future problematic development of the component. This gives the machine operator the opportunity to repair or replace the component if the machine is going to be switched off for other reasons, for example on weekends. Such an early warning is also of interest to the manufacturer of the laser processing machine as well as to service companies. If violations of the minimum tolerance value of a particular component occur frequently at a customer's site, the manufacturer or service company can make improvements to the component. Even before an inspection of a laser processing machine by a service technician, the technician can prepare for the expected work based on the stored violations of the minimum tolerance value of individual components.

Preferably, when the first tolerance value is violated, the early warning status of the associated component is communicated to the operator of the laser processing machine and to the machine manufacturer or to a service company of the machine manufacturer, and when a minimum tolerance value is violated, a selection is made, depending on the associated component and the type of error, as to whether only the machine manufacturer or a service company of the machine manufacturer is informed of the early warning status of the associated component, or whether the operator of the laser processing machine is also informed. By communicating the warning status of certain components or errors only to the manufacturer or service company, it is made possible for them to create internal statistics on this machine and/or individual components and to develop measures to prevent the occurrence of errors of these components on the machine in question or on machines of the same type at other customers. However, error and warning messages, which can also require a response from the machine operator, are forwarded to all parties involved. The method can be carried out continuously during the operation of the laser processing system.

Further advantages arise when the warning status and the early warning status of a single component or of a plurality of or all components of the laser beam source are evaluated jointly and an optical traffic light signal for the condition of the component, a group of components, or the entire laser beam source is generated therefrom, wherein a red color of the traffic light signal indicates a violation of at least one warning status without violation of an error limit value, a yellow color of the traffic light signal indicates a violation of at least one minimum tolerance value, and a green color of the traffic light signal indicates neither a violation of a minimum tolerance value nor a violation of a tolerance value.

A traffic light signal indicates the status of a component or assembly, or of the entire laser beam source, at a glance. If a yellow or red signal is issued for an assembly, the analysis can be refined and the traffic light signals of all individual components of the assembly can be queried. This makes it possible to quickly identify the component which shows a problematic tendency or is already malfunctioning.

Furthermore, a violation of a tolerance value or a minimum tolerance value caused by an operator of the laser processing system can also be indicated by a measurement value. For example, if the operator forgets to switch on the cooling of the laser source, this will be indicated to him and he can remedy the situation immediately before damage to the laser beam source occurs.

Another advantageous modification of the method is that an error status or an urgent warning status of a component is reset as soon as the measurement value of the component again falls below the associated minimum tolerance value. Previously, after correcting a fault in the laser beam source, an error or warning message had to be reset manually. If this is forgotten, a warning message will constantly appear in the machine's control unit, prompting other machine operators to immediately go to the system and eliminate the cause of the message to prevent an error message and thus a system shutdown. These problems can be avoided if falling below a minimum tolerance value is used to automatically reset error and warning messages of the associated component.

The status signals can be 32-bit data sets, of which 16 bits can be used for the output of the measurement value and 16 bits for other information such as the size of the minimum tolerance value, the frequency of exceeding the minimum tolerance value by the measurement value, etc.

The method can be designed to run in the background alongside a local fault monitoring program on the machine and is not directly coupled to the machine drive. Error messages and the shutdown of the machine or laser beam source are then carried out by the local error monitoring program.

For a comprehensive diagnosis of the condition of the laser beam source, the times at which a measurement value violates a minimum tolerance value and/or an error limit value can also be recorded.

Furthermore, it can be advantageous if the monitoring of the violation of a minimum tolerance value by a measurement value can be switched on and off. After successful installation of the machine and a longer period of trouble-free operation, permanent monitoring is not necessarily required. The method can then be carried out at intervals and over short periods of time.

Further features and advantages of the present disclosure can be found in the description and the drawings. According to the present disclosure, the features mentioned above and those explained below can be used in each case individually or together in any desired expedient combination or combinations. The embodiments shown and described should not be understood as an exhaustive list, but rather are of an exemplary character.

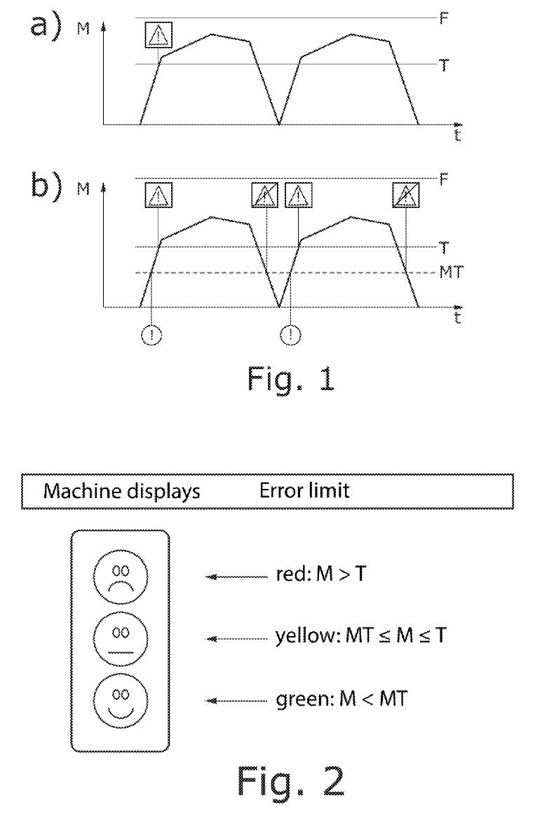

FIG. 1a shows the temporal acquisition of a measurement value M of a sensor at a laser beam source, for example for monitoring the cooling circuit, according to a prior art method. In standard monitoring methods for laser processing machines, the measurement value M is constantly compared with a predetermined tolerance value T. If the measurement value M exceeds the tolerance value T, a warning signal is generated and displayed, for example, on a display. In addition, the measurement value also monitors the violation of an error limit value, which indicates a serious problem with the associated component and generates a stop signal, triggering an interruption of the laser processing machine's production process. The monitoring of error limit values can also be carried out by a separate method in the machine. After a component fault has been rectified, the warning signal for the measurement value M must be manually reset.

FIG. 1b illustrates a method according to the present disclosure in which each tolerance value T of a measurement value M is assigned a less stringent minimum tolerance value MT. The method generates an early warning status signal if the minimum tolerance value MT is violated and transmits this signal either only to the manufacturer of the laser processing machine and a service company, or also to the operator of the machine. The method can therefore be used both for early warning of the machine operator and for internal monitoring of individual components of the laser beam source by the manufacturer and a service company. If the tolerance value T is also violated, a warning status signal is generated and displayed or transmitted. In the example shown, the measurement value M violates the minimum tolerance value MT and the tolerance value T twice, but then returns each time to the range below the minimum tolerance value MT, indicating a normal function. As soon as the measurement value M falls below the minimum tolerance value MT again, the method cancels the warning status signal, so that a further violation of the tolerance value T can be reliably detected again. The minimum tolerance value MT is therefore also used as a reset value. This eliminates the need to provide a further hysteresis limit for the measurement values.

FIG. 2 shows an example of what the status signals generated by the method according to FIG. 1b might look like. A traffic light signal 16 is generated here, which indicates the status of a component, a group of components, or the entire laser beam source. A green color indicates that the status is error-free. If the traffic light color is yellow, the minimum tolerance value MT is violated by at least one measurement value M. A red traffic light indicates a violation of a tolerance value T. In the case of serious errors, i.e., when the error limit is exceeded, a machine stop is initiated by a parallel evaluation unit for the measurement values in the laser processing machine.

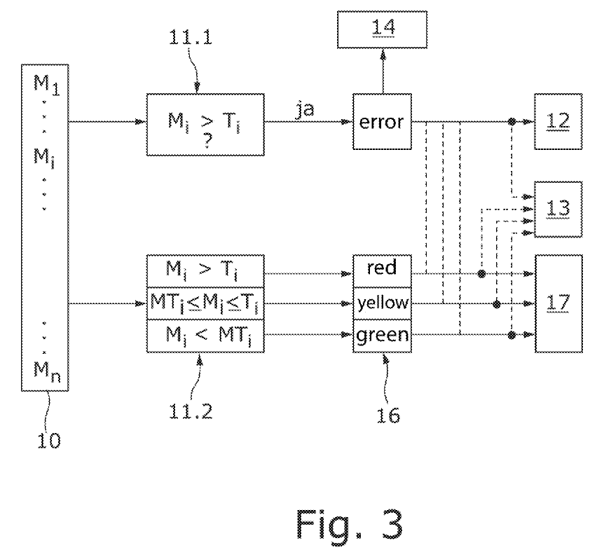

The block diagram in FIG. 3 illustrates the implementation of the method according to FIG. 1b in a laser processing machine and the further processing of the generated status signals of the components of the laser beam source.

A set 10 of measurement values Mᵢ, which were determined by sensors on the components of the laser beam source, are checked in a first evaluation unit 11.1 to see whether one of the measurement values Mᵢ violates a corresponding error limit value Fᵢ. If this is the case, an error signal “error” is generated and forwarded to the operator 12 of the machine and, if necessary, to a service company 13. In the event of serious violations of the error limit values, a stop signal is also generated for the machine drive 14.

A second evaluation unit 11.2 for implementing the method according to FIG. 1b accesses the same data set 10 of measurement values Mᵢ and compares the measurement values Mᵢ with the associated tolerance values Tᵢ and the associated minimum tolerance values MTᵢ. From the comparison result, a traffic light signal 16 is generated, which has a red color if the measurement value Mᵢ violates the tolerance value Tᵢ. If the measurement value Mᵢ violates the minimum tolerance value MT_{i,} but not yet the tolerance value Tᵢ , the traffic light signal 16 shows a yellow color. If none of the values Tᵢ or MTᵢ are violated, a green color is displayed in the traffic light signal 16. This traffic light signal 16 is either only forwarded to the manufacturer 17 of the laser processing machine and/or to a service company 13, or it is also displayed to the operator 12 of the machine.

The implementation of the method shown in FIG. 3 is merely an example. The evaluation unit 11.1 can also be completely dispensed with. Furthermore, the status signals can also be represented in a form other than a traffic light signal 16. Furthermore, the measurement values of several components of the laser beam source can be combined and jointly evaluated for the generation of status signals.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for monitoring a status of components of a laser beam source in a laser processing machine, the method comprising:
determining measurement values of properties of interest of the components of the laser beam source;
comparing each of the measurement values with an error limit value, a faulty status of the component being indicated based on the measurement value falling below or exceeding the error limit value;
based on the error limit value being violated by the component, assigning an error status and shutting down the laser beam source;
defining, for each error limit value, a tolerance value, the violation of which by at least one measurement value of the measurement values results in a warning status being assigned,
wherein each error limit value is associated with a second, minimum tolerance value which is more narrowly defined than the tolerance value; and
assigning an early warning status based on violation of the second, minimum tolerance value by at least one measurement value of the measurement values of the component.

2. The method according to claim 1, wherein, based on the tolerance value being violated, the warning status of the associated component is communicated to an operator of the laser processing machine and to a machine manufacturer or to a service company of the machine manufacturer, and based on a minimum tolerance value being violated, a selection is made, depending on the associated component and a type of error, as to whether only the machine manufacturer or a service company of the machine manufacturer is informed of the early warning status of the associated component, or whether the operator of the laser processing machine is also informed.

3. The method according to claim 1, wherein the method is carried out continuously during the operation of the laser processing system.

4. The method according to claim 1, wherein the warning status and the early warning status of a single component or of a plurality of or all components of the laser beam source are evaluated jointly and an optical traffic light signal for the condition of the component, a group of components, or the entire laser beam source is generated therefrom,
wherein a red color of the traffic light signal indicates a violation of at least one warning status without violation of at least one of the error limit values, a yellow color of the traffic light signal indicates a violation of at least one of the minimum tolerance values, and a green color of the traffic light signal indicates neither a violation of any of the minimum tolerance values nor a violation of any of the tolerance values.

5. The method according to claim 1, comprising resetting the error status or the warning status of a respective component of the components as soon as the measurement value of the component falls below the associated minimum tolerance value.

6. The method according to claim 1, wherein a violation of a tolerance value or a minimum tolerance value caused by an operator of the laser processing system is also indicated by at least one of the measurement values.

7. The method according to claim 6, wherein a violation of at least one of the tolerance values or at least one of the minimum tolerance values caused by the operator of the laser processing system is also indicated to a manufacturer of the laser processing system or to a service company.

8. The method according to claim 1, wherein the status signals of the components are encoded in 32-bit data sets.

9. The method according to claim 1, wherein the times at which at least one of the measurement values violates at least one of the minimum tolerance values and/or at least one of the tolerance values are also recorded.

10. The method according to claim 1, wherein the monitoring of the violation of the minimum tolerance values by the measurement values can be switched on and off.
